(19) United States
(12) Patent Application Publication
(10) Pub. No.: US 2014/0303312 A1
(43) Pub. Date: Oct. 9, 2014

(54) FLOURINATED SILANE-MODIFIED POLYACRYLIC RESIN

(71) Applicant: THE SHERWIN-WILLIAMS COMPANY, (US)

(72) Inventor: Richard F. Tomko, North Olmsted, OH (US)

(73) Assignee: THE SHERWIN-WILLIAMS COMPANY, Cleveland, OH (US)

(21) Appl. No.: 13/839,309

(22) Filed: Mar. 15, 2013

(51) Int. Cl. C08F 220/22

(52) U.S. Cl. CPC C08F 220/22
USPC 524/544; 526/245

(57) ABSTRACT

A fluorinated silane-modified polyacrylic resin comprising: (a) 1% to 50% by weight of at least one acrylic ester monomer; (b) 1 to 50% by weight of an ethylenically unsaturated monomer; (c) 1% to 50% by weight of an organofunctional silane monomer; and (d) 0.1% to 50% by weight of a fluorine-containing monomer.

### BACKGROUND OF INVENTION

This invention is directed to a moisture-curable fluorinated silane-modified polyacrylic resin, wherein self-stratifying fluoroester monomers such as 2,2,2-trifluoroethyl methacrylate or fluorinated methacrylates such as pentafluoromethacrylate esters or octafluorinated methacrylate esters or perfluoro monomers are incorporated into an acrylic polymer.

### SUMMARY OF THE INVENTION

A fluorinated silane-modified polyacrylic resin comprising: (a) 1% to 50% by weight of at least one acrylic ester monomer; (b) 1 to 50% by weight of an ethylenically unsaturated monomer; (c) 1% to 50% by weight of an organofunctional silane monomer; and (d) 0.1% to 50% by weight of a fluorine-containing monomer.

### DETAILED DESCRIPTION

In the follow ing description, it is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. In one embodiment, the invention comprises fluorinated silanated polyacrylic resin of the following general formula:

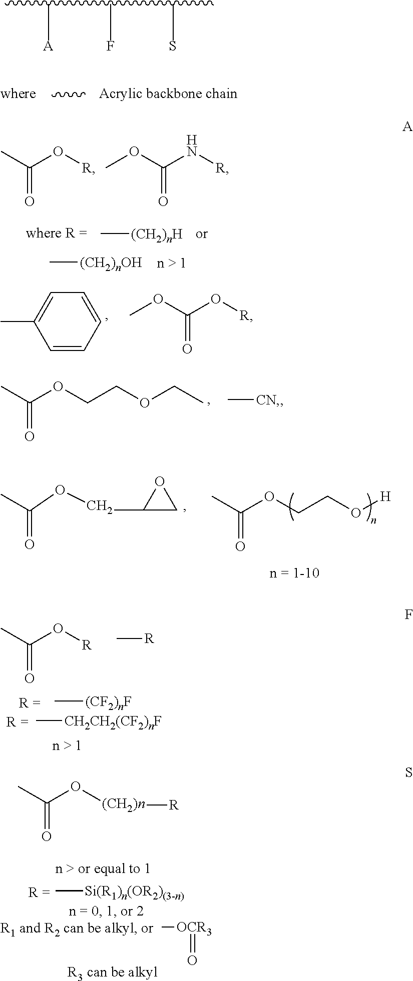

A silane-modified polyacrylic resin can be derived from a polyacrylic resin modified with a moisture-curable silanated functional monomer. For example, isocyanatosilane or isocyanato-fluorinated functionality can be reacted with hydroxyfunctional polyacrylic resin to produce polyacrylic resins grafted with silane or fluorine. In another embodiment, a moisture-curable silane-modified polyacrylic resin can be prepared by free radical polymerization of acrylic monomers with moisture-curable, polymerizable silanated monomers such as (meth)acrylate or vinyl monomers with alkoxysilane functionality, such as the following: trialkoxysilyl alkyl (meth)acrylates, 3-((meth)acryloyloxy)propyltrimethoxysilane (trimethoxysilyl propyl (meth)acrylate), triethoxysilyl propyl (meth)acrylate, methacryloxymethyl trimethoxysilane, methacryloxymethyl triethoxysilane, (methacryloxymethyl) methyldimethoxysilane, (methacryloxymethyl) methyldiethoxysilane, vinyl trialkoxy silane, vinyl trimethoxy silane, triethoxy silane. A general synthesis of such moisture-curable silane-modified polyacrylic resins can be found in U.S. Pat. Nos. 7,943,698 (Tomko) and 7,074,856 (Ho).

The fluorinated silane-modified polyacrylic resin can be derived from a polyacrylic resin modified with a moisture-curable silanated and fluorinated functionality. One method to prepare a fluorinated, moisture-curable, silane-modified polyacrylic resin is by free radical polymerization of acrylic monomers with moisture-curable, polymerizable silanated monomers and fluorine-containing monomers. Examples of fluorine-containing monomers can include perfluorinated monomers or a fluorine-containing monomer having the structure (I):

CH₂═CR C(O)O—(CH₂)—R_{f} (I)

wherein R is hydrogen or methyl, n is an integer in the range of from 0 to 20, and R_{f} is a fluoroalkyl group having in the range of from l to 20 carbon atoms. In one embodiment, R is methyl, n is 2 and R_{f} is C₆F₁₃ which is commercially available as CAPSTONE™ 62-MA, methcaryloxy 3,3,4,4,5,5,6,6,7,7,8,8,8-tridecafluorooctyl ester (perfluorohexyl ethyl (meth)acrylate), from DuPont, Wilmington, Del. Examples of suitable fluorine containing monomers according to formula (I) can include, for example, 2,2,2-trifluoroethyl methacrylate, perfluoromethyl ethyl (meth)acrylate, perfluoroethyl ethyl (meth)acrylate, perfluorobutyl ethyl (meth)acrylate, perfluoropentyl ethyl (meth)acrylate, perfluorohexyl ethyl (meth)acrylate, perfluorooctyl ethyl (meth)acrylate, perfluorodecyl ethyl (meth)acrylate, perfluorolauryl ethyl (meth)acrylate, perfluomstearyl ethyl (meth)acrylate or combinations thereof. Other fluorinated monomers are known in the art and can be used.

The fluorinated resin can further comprise monomers such as, Rif example, methyl (meth)acrylate, ethyl (meth)acylate, propyl (meth)acrylate, isopropyl (meth)acylate, butyl (meth)acrylate, isobutyl (meth)acrylate, t-butyl (meth)acrylate, pentyl (meth)acrylate, hexyl (meth)acrylate, 2-ethylhexyl (meth)acrylate, cyclohexyl (meth)acrylate, 2,2,5-trimethylcyclohexyl (meth)acrylate, isobornyl (meth)acrylate,octyl (meth)acrylate, nonyl (meth)acrylate, decyl (meth)acrylate, laury (meth)acrylate, stearyl (meth)acrylate, styrene, alpha methyl styrene, (meth)acrylamide, (meth)acrylonitrile, hydroxy (meth)acrylamide; hydroxy alkyl (meth)acrylates, hydroxy methyl (meth)acrylate, hydroxy ethyl (meth)acrylate, hydroxy propyl. (meth)acrylate, hydroxy butyl (meth)acrylate; glycidyl (meth)acrylate, (meth)acrylic acid, ether and polyether extended alkyl (meth)acrylates, 2-ethoxy ethyl (meth)acrylate, 2-butoxy ethyl (meth)acrylate, poly(ethylene glycol) (meth)acrylate, polyester extended (meth)acrylate esters, caprolactone-extended hydroxyalkyl (meth)acrylates or a combination thereof, wherein the notation (meth)acrylate means acrylate or methacrylate. Multi-functional monomers may be used in minor amounts as long as the polymer does not gel during polymerization.

In one embodiment, the fluorinated silane-modified polyacrylic resin contains pendant organofunctional silane groups comprises a mixture of (a) 1% to 50% by weight of one or more ethylenically unsaturated monomers, and vinyl compounds such as styrene, acrylonitrile, α-methyl styrene; 1% to 50% by weight of a moisture-curable, organofunctional silane monomer and 0.1% by weight to 50% by weight of a fluorine-containing monomer as defined above, based on the total weight of monomers.

Examples of useful moisture-curable, organofunctional silane monomers according to this invention include alpha-silanes such as trialkoxysilyl alkyl (meth)acrylates, 3-((meth)acryloyloxy) propyltrimethoxysilane (trimethoxysilyl propyl (meth)acrylate), triethoxysilyl propyl (meth)acrylate vinyl trialkoxy silane, vinyl trimethoxy silane, and vinyl triethoxy silane,

Other organofunctional silane monomers include trialkoxysilyl alkyl (meth)acrylate monomers such as (methacryloxymethyl) methyldimethoxysilane, (methacryloxymethyl)trimethoxysilane, (methacryloxymethyl)methyldiethoxysilane, and (methacryloxymethyl)triethoxysilane, GENIOSIL® XL-30 series, such as GENIOSIL® XL-32, XL-33, XL-34 and XL-36, available from Wacker Chemie AG, may be used.

The amount of organofunctional silane present in the fluorinated polyacrylic resin polymer composition can be about 1% to about 50% by weight, preferably 2% to 25% by weight, and most preferably, 5% to 15% by weight, of the total weight of monomers.

The amount of fluorine-containing monomer present in the fluorinated, silanated polyacrylic resin polymer composition can be about 0.1% to about 50% by weight, preferably 0.5% to 25% by weight, and most preferably, 1% to 15% by weight, of the total weight of monomers.

The polymerization or other modification of the fluorinated, silanated polyacrylic resin is preferably carried out in a non-functional volatile solvent, such as xylene, toluene, and other aromatics, t-butyl acetate, n-butyl acetate, ethyl-3-ethoxypropionate, p-chlorobenzotrifluoride, acetone, methyl ethyl ketone, and other ester solvents. In general, suitable solvents or reactive diluents include those that will not polymerize with the monomers. However, alcoholic solvents may be used or added after polymerization. Reactive diluents, that may be used in the polymerization reaction to replace the solvents or in addition to the solvents may be silicone resins, especially liquid, reactive silicone resins such as SY-231 available from WACKER; DC-3074 available from DOW CORNING Corporation of Midland Michigan, and the SILIKOPON or SILIKOFTAL epoxy polysiloxane resins from DEGUSSA.

Generally, any of the free radical initiators known to the art can be utilized. Suitable free radical initiators include any of the alkyl peroxides such as tert-amyl and tert-butyl peroxides, di-tert-butyl peroxide, peresters such as tert-butyl perbenzoate, tert-butyl peroxy-3,5,5-trimethylhexanoate, 2,5-bis(2-ethylhaxanoyl-peroxy)-2,5-dimethylhexane, or tertiary butyl peroctoate, and any of the various known azo initiators such as 2,2′-azobisisobutyronitrile. Particularly preferred are 2,2′-azobisisobutyronitrile or 2,2′-azo-bis(2-methylbutyronitrile) (Vazo 67 from DuPont). For example, the weight of the free radical initiator used (by weight based on monomers) is generally at least 0.5%. A chain transfer agent, such as a mercaptosilane chain transfer agent (for example, (3-mercaptopropyl)trimethoxysilane, Silquest® A-189 available from Momentive Corporation) can be utilized during the free radical polymerization of the invention. In addition, other chain transfer agents could be used with A-189 such as alkyl thiols (e.g. dodecanthiol) and the like. The amount of chain transfer agent used (by weight based on monomers) is generally at least 0.5%, preferably 1 to 10%, or a level of 0.5 to 7% initiator can be used in conjunction with 1 to 10% chain transfer agent.

As an example, the fluorinated silane-modified polyacrylic resins, the solvent is charged to the reactor and the monomers, silane-containing monomer, fluoro-containing monomer(s) and initiator and chain transfer agent can be mixed together as one feed, and then polymerized and chased with additional solvent and initiator. For example, the solvent can be heated to a temperature at about 102° C., and the monomers, initiator, and chain transfer agent can be added over a period of 2-4 hours, preferably in 3 hours, while the temperature of the solution is maintained during the addition and for a further period of 0.5 to 4 hours after the addition. Then a further charge of initiator (chase) may be added during this further period to reduce the level of unreacted monomer. The level of unreacted monomer may be further reduced with additional charges of initiator. However, it is also possible to reduce this level by distilling off the unreacted monomer from the reaction mixture.

In an embodiment, the fluorinated resin comprises a mixture of (a) 1% to 50% by weight of one or more ethylenically unsaturated monomers, whereby at least one of the unsaturated monomers can be an acrylic ester such as butyl (meth)acrylate, methyl (meth)acrylate, ethyl (meth)acrylate, propyl (meth)acrylate, n-hexyl (meth)acrylate, isopropyl (meth)acrylate, isobutyl (meth)acrylate, 2-ethylhexyl (meth)acrylate, cyclohexyl (meth)acrylate, 2,2,5-trimethylcyclohexyl (meth)acrylate, isobornyl (meth)acrylate, and lauryl (meth)acrylate; (b) 1 to 50% by weight of an unsaturated monomer such as styrene, acrylonitrile, α-methyl styrene; and (c) 1% to 50% by weight of an organofunctional etsilane monomer; and (d) 0.1% to 50% by weight of a fluorine-containing monomer.

### Example

### Fluorinated Silane-Modified Polyacrylic Resin

To a 3-Liter reactor equipped with a nitrogen inlet, stirrer, condenser, thermocouple and feed inlet, 225 g of n-butyl acetate was charged and heated to 102° C. A mixture of 275 g methyl methacrylate, 312.9 g 2-ethylhexylacrylate, 108 g mercaptopropyltrimethoxysilane (SILQUEST A-189, Momentive), 186.2 g styrene, 121 g methacryloxymethyltrimethoxysilane (Geniosil XL-33, Wacker), 85 g 2,2,2-trifluoroethylmethacrylate (TOSOH USA), and 26 g VAZO 67 (DuPont USA) was added over three hours, and then the reaction was held for 30-minutes at 102° C.

A mixture of 15 g VAZO 67 and 75 g n-butyl acetate was added as a chase to reduce residual monomer over 2.5 hours, and then held for another 30-minutes at 102° C.

A second chase consisting of 5 g VAZO 67 and 25 g n-butyl acetate was added over 90-minutes, held another 30-minutes at 102° C., and filtered while hot through a 25-micron filter bag.

NVM (non-volatile material)=73.4%

Viscosity (Brookfield Viscometer LVT #3 Spindle at 25C)=1232 centipoise (cps)

1. A fluorinated silane-modified polyacrylic resin comprising: (a) 1% to 50% by weight of at least one acrylic ester monomer; (b) 1 to 50% by weight of an ethylenically unsaturated monomer; (c) 1% to 50% by weight of an organofunctional silane monomer;
and (d) 0.1% to 50% by weight of a fluorine-containing monomer.

2. The polyacrylic resin of claim 1, wherein the acrylic ester monomer is selected from the group consisting of butyl (meth)acrylate, methyl (meth)acrylate, ethyl (meth)acrylate, propyl (meth)acrylate, n-hexyl (meth)acrylate, isopropyl (meth)acrylate, isobutyl (meth)acrylate, 2-ethylhexyl (meth)acrylate, cyclohexyl (meth)acrylate, 2,2,5-trimethylcyclohexyl (meth)acrylate, isobornyl (meth)acrylate, and lauryl (meth)acrylate.

3. The polyacrylic resin of claim 1, wherein the organofunctional silane monomer is an alpha-silane selected from the group consisting of (methacryloxymethyl) methyldimethoxysilane, (methacryloxymethyl)trimethoxysilane, (methacryloxymethyl)methyldiethoxysilane, and (methacryloxymethyl)triethoxysilane

4. The polyacrylic resin of claim 1, wherein the organofunctional silane monomer is a trialkoxysilyl alkyl (meth)acrylate monomer is selected from the group consisting of 3-((meth)acryloyloxy)propyltrimethoxysilane (trimethoxysilyl propyl (meth)acrylate), triethoxysilyl propyl (meth)acrylate, methacryloxymethyl trimethoxysilane, methacryloxymethyl triethoxysilane, (methacryloxymethyl) methyldimethoxysilane, (methacryloxymethyl) methyldiethoxysilane, vinyl trialkoxy silane, vinyl trimethoxy silane, vinyl triethoxy silane.

5. The polyacrylic resin of claim 1, wherein the ethylenically unsaturated monomer is selected from the group consisting of styrene, acrylonitrile, α-methyl styrene.

6. The polyacrylic resin of claim 1, wherein the fluorine-containing monomer has a structure:
CH₂═CR C(O)O—(CH₂)—R_{f} (I)
wherein R is hydrogen or methyl, n is an integer in the range of from 0 to 20, and R_{f} is a fluoroalkyl group having in the range of from 1 to 20 carbon atoms.

7. The polyacrylic resin of claim 1, wherein the fluorine-containing monomer is selected from the group consisting of 2,2,2-trifluoroethyl methacrylate, perfluoromethyl ethyl (meth)acrylate, perfluoroethyl ethyl (meth)acrylate, perfluorobutyl ethyl (meth)acrylate, perfluoropentyl ethyl (meth)acrylate, perfluorohexyl ethyl (meth)acrylate, perfluorooctyl ethyl (meth)acrylate, perfluorodecyl ethyl (meth)acrylate, perfluorolauryl ethyl (meth)acrylate, perfluorostearyl ethyl (meth)acrylate or combinations thereof.

8. A coating composition comprising (a) the resin of claim 1; and (b) a curing agent, selected from the group consisting of aminosilane, aminoalkyl silane, aminosilanes having two or three silicon atoms, and aminosilanes with one or more amine groups, or combinations thereof.
